(19) United States
(12) Patent Application Publication
(10) Pub. No.: US 2009/0217254 A1
(43) Pub. Date: Aug. 27, 2009

(54) APPLICATION LEVEL SMART TAGS

(75) Inventors: Misha Shneerson, Redmond, WA (US); Andrew Whitechapel, Seattle, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/035,442

(22) Filed: Feb. 22, 2008

(51) Int. Cl. G06F 9/44; G06F 3/048

(52) U.S. Cl. 717/168; 715/764

(57) ABSTRACT

Smart tag functionality is enabled in documents at an application level. An application add-in module configured to be loaded into an application includes a recognizer module and an action module. The recognizer module is configured to recognize a textual object in a plurality of documents open in an application and to assign a smart tag to the recognized textual object. The action module is configured to indicate an action in an interface provided in a document proximate to the smart tag if a user interacts with the smart tag in the document. The action module is configured to enable the action to be performed if the user selects the action in the provided interface.

### BACKGROUND

Smart tags are a user interface feature which can recognize text in a document and provide a user with a set of options for handling the recognized text. When smart tags are enabled with regard to a document, the document is searched in an attempt to recognize text (e.g., words or phrases) in the document that has been predetermined to be of interest, such as names, events, places, etc. Any such recognized text is automatically converted into a smart tag. A smart tag is typically identified in a document by a dotted, colored underline of the recognized text, in a similar fashion to a hyperlink. If a user viewing the document clicks on a smart tag, a list of possible actions for that particular smart tag is provided. Examples of possible actions include performing a Web search on the smart tag text, opening a contacts list, and scheduling a meeting.

Smart tags are supported in various applications. For example, smart tags are supported by applications included in Microsoft® Office (e.g., Microsoft® Word and Microsoft® Excel), which is published by Microsoft Corporation of Redmond, Wash.

Smart tags may be implemented with regard to a document in several ways. In a first implementation, smart tags are associated at an application suite level. In such an implementation, smart tags are configured for use in all documents handled by applications of an application suite. For example, a smart tag may be configured to be accessible by all documents handled by the applications of a particular installation of Microsoft® Office.

In a second smart tag implementation, smart tags are associated directly with a selected document. In such an implementation, the smart tags are configured for use in the selected document, but are not available for use in other documents. For example, Microsoft® Visual Studio® Tools for Office (VSTO), which is published by Microsoft Corporation of Redmond, Wash., is a development tool that enables document level customizations to be generated for documents of Microsoft® Word and Microsoft® Excel®. VSTO enables smart tags to be integrated into the document level customizations. Thus, using VSTO, smart tags can be associated with a particular document by providing the document with a customization that integrates the smart tags.

Both of these conventional implementations for smart tags have deficiencies. Both implementations require non-standard user code to be generated to enable the smart tag functionality. With regard to the second implementation, the smart tags must be separately configured for each document in which the smart tags are desired to function. With regard to the first implementation, the smart tags must be registered in a non-standard manner. Specially created interfaces must be developed to specify the list of text to be recognized, and to specify the actions to be performed when text is recognized. The user code required to implement these specially created interfaces is complex and prone to errors, leading to long and costly development cycles.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Add-ins are described that enable smart tag functionality in documents at an application level.

In accordance with one implementation, an application add-in module is provided. The application add-in module is configured to be loaded into an application. The add-in module includes a recognizer module and an action module. The recognizer module is configured to recognize a textual object in a plurality of documents open in the application and to assign a smart tag to the recognized textual object. The action module is configured to indicate an action in an interface provided in a document proximate to the smart tag if a user interacts with the smart tag in the document. The action module is configured to enable the action to be performed if the user selects the action in the provided interface.

Methods for enabling smart tag functionality in documents at an application level are also described.

In one method, an application add-in module is generated that is configured to be loaded into an application. The method includes opening an add-in project. The method further includes defining in the add-in project a smart tag that includes a textual object and an action. The method further includes generating an add-in module based on the add-in project.

A computer program product is also described herein. The computer program product includes a computer-readable medium having computer program logic recorded thereon for enabling a computer to implement an application add-in module.

In accordance with one implementation of the computer program product, the computer program logic includes first, second, and third means. The first means are for enabling the computer to recognize a textual object in a plurality of documents open in an application and to assign a smart tag to the recognized textual object. The second means are for enabling the computer to indicate an action associated with the smart tag in an interface in a document open in the application if a user interacts with the smart tag in the document. The third means are for enabling the computer to perform the action if the user selects the action in the interface.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 shows a block diagram of an example smart tag in a document.

FIG. 2 shows a block diagram of example smart tag source information.

FIG. 3 shows a system for providing smart tag functionality to a document.

FIG. 4 shows an example of smart tag source information in table form.

FIG. 5 shows an example document having text that includes smart tags.

FIG. 6 shows an example of a user interacting with a smart tag in the document of FIG. 5.

FIG. 7 shows a system for associating smart tags with an application suite.

FIG. 8 shows a system for associating smart tags with a document.

FIG. 9 shows a block diagram of a system illustrating the loading of an add-in into an application.

FIG. 10 shows a block diagram of a system illustrating the loading into an application of an add-in that incorporates smart tag functionality, according to an example embodiment of the present invention.

FIG. 11 shows a block diagram of an application that has smart tag functionality enabled, according to an example embodiment of the present invention.

FIG. 12 shows a flowchart for developing an add-in module that includes smart tag functionality, according to an example embodiment of the present invention.

FIG. 13 shows a block diagram of an add-in development system, according to an example embodiment of the present invention.

FIG. 14 shows a flowchart that may be performed during the flowchart of FIG. 12, according to an example embodiment of the present invention.

FIG. 15 shows a flowchart for enabling smart tag functionality in an application, according to an example embodiment of the present invention.

FIG. 16 shows a block diagram of an add-in module having smart tag functionality that is loaded into an application, according to an example embodiment of the present invention.

FIG. 17 shows a block diagram of an example computer that may be used to develop add-ins and smart tags, and/or run to applications that incorporate smart tags, according to an embodiment of the present invention.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### Introduction

The present specification discloses one or more embodiments that incorporate the features of the invention. The disclosed embodiment(s) merely exemplify the invention. The scope of the invention is not limited to the disclosed embodiment(s). The invention is defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

### Example Smart Tags

Embodiments of the present invention described herein relate to smart tags. Smart tags are a user interface feature which can recognize text in a document and provide a user with a set of options for interacting with the recognized text. Conventional smart tag implementations are supported in various applications, including Microsoft® Word and Microsoft® Excel of Microsoft® Office, which are published by Microsoft Corporation of Redmond, Wash., and in further types of applications. When smart tags are enabled with regard to a document, the document is searched in an attempt to recognize predetermined text (e.g., words or phrases) of interest, such as names, events, places, etc. Any such recognized text in the document is automatically converted into a smart tag.

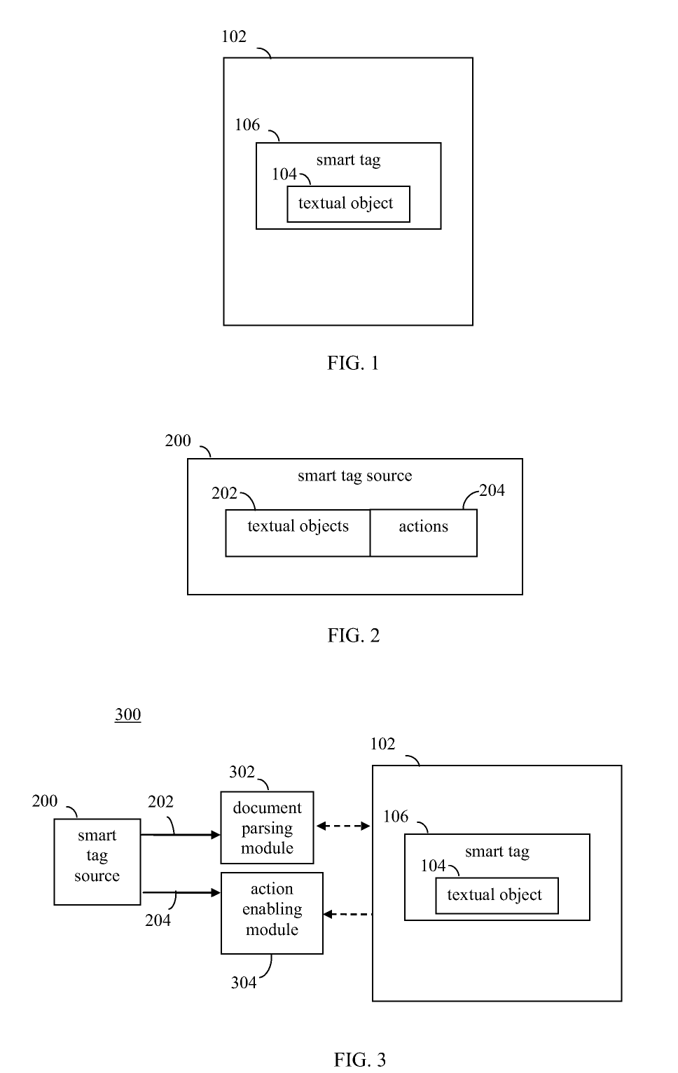

FIGS. 1-3 show some basic features of smart tag functionality. FIG. 1 shows a block diagram of an example conventional smart tag 106 present in a document 102. As shown in FIG. 1, smart tag 106 is associated with a textual object 104. Textual object 104 may be a word, a collection of words, or a phrase of interest. When textual object 104 is present in document 102, textual object 104 is converted into smart tag 106, and an indication of smart tag 106 is displayed with textual object 104 in document 102. Smart tag 106 may be displayed in document 102 in any manner, including a typical identification technique of a dotted, colored underline of textual object 104. If a user viewing document 102 activates smart tag 106 by positioning a mouse pointer over smart tag 106, tabbing through displayed smart tags until reaching smart tag 106, and/or by otherwise interacting with smart tag 106, a list of possible actions for smart tag 106 is provided with which the user can interact.

FIG. 2 shows a block diagram of smart tag source information 200, which includes parameters related to one or more smart tags. Smart tag source information 200 may have the form of software code, pseudo-code, or other representation that defines functionality of one or more of smart tags 106. For instance, smart tag source information 200 may be included in a file referenced by a Windows® registry (e.g., a dynamic link library (DLL) file) or other type of registry. As shown in FIG. 2, smart tag source information 200 includes textual objects 202 and actions 204. Textual objects 202 include one or more words/phrases to be searched for in a document (e.g., document 102) for conversion into a smart tag. Actions 204 include one or more actions to be displayed when smart tags formed by the corresponding words/phrases of textual objects 202 are activated in the document. Smart tags may be activated in various ways, including by positioning a mouse pointer over the smart tag in the document, by clicking on the smart tag, by tabbing through displayed smart tags, and/or by otherwise interacting with the smart tags. A displayed action of the smart tag may be selected by using a mouse pointer to click on an action in the list, by using arrow keys to choose an action and pressing a key to select the action, or by otherwise selecting the action.

Smart tag source information 200 may be used to define smart tags for a document. FIG. 3 shows a system 300 for implementing smart tag functionality in a document, such document 102. As shown in FIG. 3, system 300 includes smart tag source 200, a document parsing module 302, and an action enabling module 304. Document parsing module 302 receives textual objects 202 from smart tag source information 200. Document parsing module 302 parses the text of document 102 for instances of the words/phrases of textual objects 202 in document 102. For each instance of a word/phrase of textual objects 202 in document 102 (such as textual object 104 shown in FIG. 3), a smart tag is assigned to the recognized word/phrase (e.g., as shown in FIG. 3, smart tag 106 is associated with textual object 104). Action enabling module 304 enables performance of an action of actions 204 corresponding to a smart tag selected in document 102 by a user.

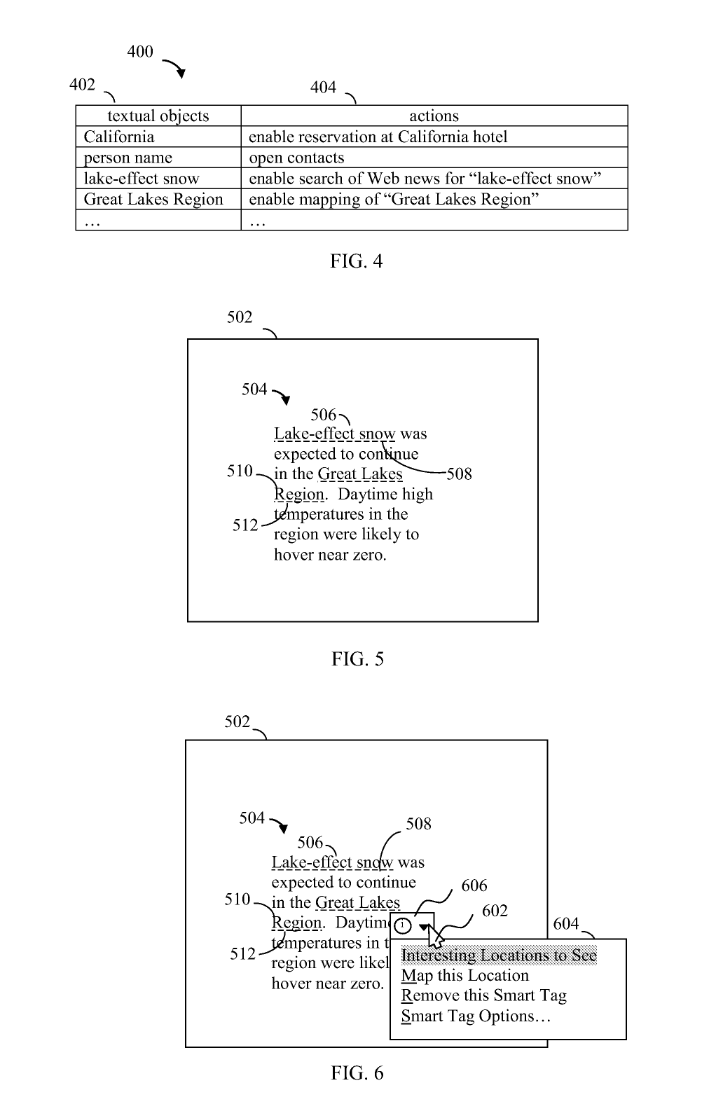

FIGS. 4 and 5 illustrate some examples of smart tags being assigned to text in a document. FIG. 4 shows smart tag source information 400, which includes four examples of textual objects and corresponding actions (e.g., as an example of smart tag source information 200 shown in FIG. 2). As shown in FIG. 4, smart tag source information 400 includes a first column 402 and a second column 404. First column 402 lists textual objects (e.g., textual objects 202), and second column 404 lists actions (e.g., actions 204). Each row of smart tag source information 400 includes an action in column 404 corresponding to the textual object of column 402. For example, the third row of smart tag source information 400 lists “lake-effect snow” as a textual object, and lists a corresponding action of enabling a search of Web news for “lake-effect snow.” The fourth row of smart tag source information 400 lists “Great Lakes Region” as a textual object, and lists a corresponding action of enabling a mapping of the Great Lakes region. Although smart tag source information 400 is described herein as including textual objects and associated actions formatted in rows and columns, smart tag source information 400 may be embodied in various other ways, including in the form of other data structures that associate textual objects and action, either directly or by reference.

Note that although a single action is provided for each textual object in FIG. 4, multiple actions may be provided for a single textual object if desired. Furthermore, a single action may be assigned to multiple textual objects if desired.

When smart tag source information 400 is received by document parsing module 302, document parsing module 302 parses the text of a document for the textual objects listed in first column 402. For instance, document parsing module 302 may receive a document 502 shown in FIG. 5. Document 502 has a text portion 504 that includes the text “lake-effect snow,” which is a textual object in smart tag source information 400. As a result, a first smart tag 506 is assigned to “lake-effect snow,” which is indicated by a first dotted underline indicator 508 in FIG. 5. In a similar manner, a second smart tag 510 may be assigned to “Great Lakes Region” in document 502, which is listed as a textual object in the fourth row of smart tag source information 400. Second smart tag 510 is indicated in FIG. 5 by a second dotted underline indicator 512.

FIG. 6 shows an example of a user interacting with second smart tag 510. In the example of FIG. 6, the user positioned a mouse pointer 602 over second smart tag 510 to cause a pop-up graphical user interface (GUI) 604 to appear proximate to mouse pointer 602. Pop-up GUI 604 may initially appear as a minimized menu 606 that may be expanded by clicking on minimized menu 606. Pop-up GUI 604 indicates one or more actions associated with second smart tag 510. As indicated in second column 404 of smart tag source information 400, the action associated with “Great Lakes Region” enables a map of the “Great Lakes Region.” As shown in FIG. 6, pop-up GUI 604 displays the text “Interesting Locations to See” as a title for second smart tag 510. Pop-up GUI 604 further displays actions that may be taken, including the action “Map this Location.” Pop-up GUI 604 may further display additional actions for second smart tag 510, including “Remove this Smart Tag” and “Smart Tag Options,” which may be default smart tag actions for all smart tags. By clicking on one of the listed actions in GUI 604, the corresponding action may be enacted. For example, by clicking on “Map this Location,” a map generating tool may be invoked that generates and displays a map of the Great Lakes region.

Thus, smart tags enable actions to be associated with text in documents. Many types of actions may be enabled. For example, actions such as opening a contacts list, performing a measurement conversion, adding an appointment to a calendar, looking up a stock symbol, etc. Note that the above described examples of smart tags are provided for purposes of illustration, and are not intended to be limiting. Other configurations of smart tags, including further types of actions associated with smart tags, will be apparent to persons skilled in the relevant art(s).

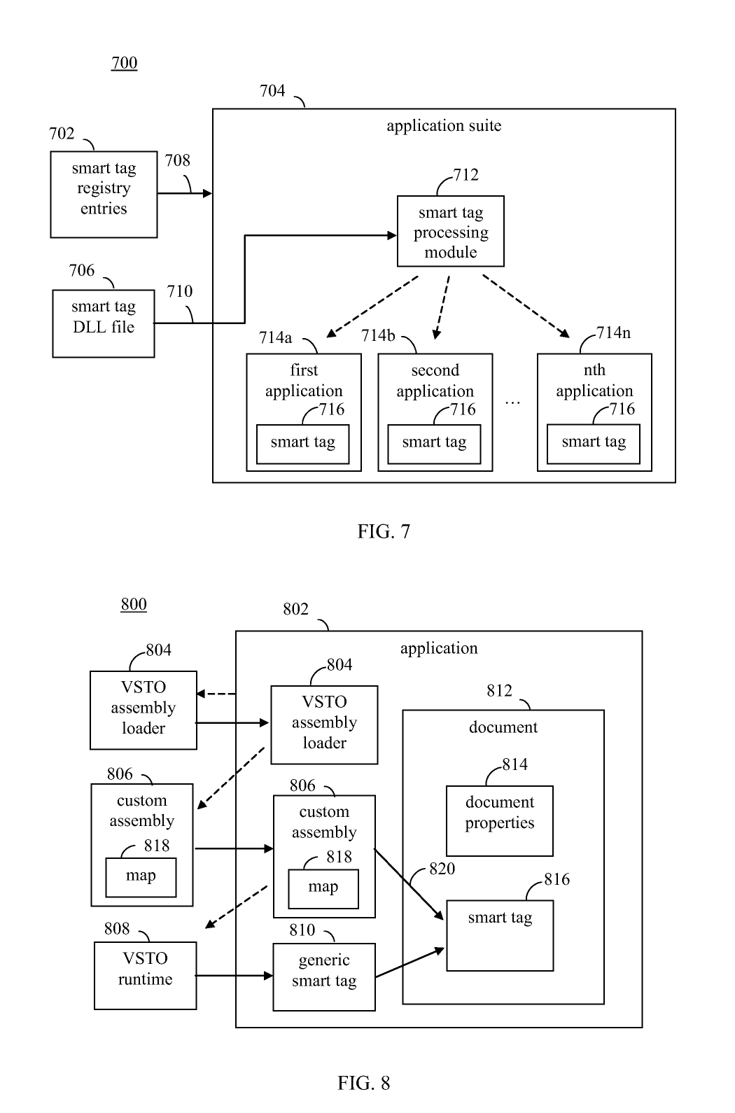

Smart tags may be conventionally associated with a document in two ways. In a first technique, a smart tag is associated with a suite of applications to provide smart tag functionality to all documents handled by applications of the application suite. For example, FIG. 7 shows a system 700 for associating smart tags with an application suite 704. Application suite 704 may be any type of application suite, including an office suite such as Microsoft® Office. As shown in FIG. 7, system 700 includes smart tag registry entries 702, a smart tag DLL file 706, and application suite 704. Application suite 704 includes a smart tag processing module 712 and a plurality of applications 714a-714n. Applications 714a-714n may include any combination of types of applications, including word processing applications, spreadsheet applications, presentation generating applications, drawing applications, etc. In the example where application suite 704 is Microsoft® Office, applications 714a-714n may include Microsoft® Word, Microsoft® Excel, Microsoft® Access™, Microsoft® PowerPoint®, and Microsoft® Outlook®, which are published by Microsoft Corporation of Redmond, Wash. Any number of applications 714 may be present in application suite 704.

In the example of FIG. 7, smart tag registry entries 702 are read by application suite 704 upon the opening of an application of application suite 704 (e.g., one of applications 714a-714n). Application suite 704 determines from smart tag registry entries 702 the existence of a file that contains smart tag data, which is smart tag DLL file 706 in the current example. A smart tag processing module 712 of application suite 704 loads smart tag DLL file 706, and provides smart tag functionality, as described above, for applications 714a-714n of application suite 704. Because application suite 704 loads the same smart tag DLL file 706 when any one of applications 714a-714n is opened, the same smart tag functionality is provided in all documents handled by all of applications 714a-714n. For example, a smart tag 716 based on the same textual object and corresponding action will be available to all documents handled by applications 714a-714n.

Note that in some implementations, application suite 704 may be capable of controlling which of applications 714a-714b have access to smart tag DLL file 706. In this manner, application suite 704 may be able to provide smart tag functionality to some of applications 714a-714n while withholding smart tag functionality to others of applications 714a-714n.

In a second technique implementing smart tags, a smart tag may be directly associated with a particular document. For example, FIG. 8 shows a system 800 for associating smart tags with a document 806 in manner supported by Microsoft® Visual Studio® Tools for Office (VSTO), published by Microsoft Corporation of Redmond, Wash. VSTO is a development tool that enables document level customizations to be generated for documents of Microsoft® Word and Microsoft® Excel®. VSTO enables smart tags to be integrated into the document level customizations created in VSTO.

As shown in FIG. 8, system 800 includes an application 802, a VSTO assembly loader 804, a custom assembly 806, and a VSTO runtime 808. In the current example, application 802 is an application of Microsoft® Office, such as Microsoft® Word or Microsoft® Excel®. Application 802 has opened document 812. Document 812 includes text (not shown in FIG. 8) and document properties 814. Document properties 814 are properties associated with document 812. Application 802 analyzes document properties 814 to determine whether a customized assembly has been created for application 802. If document properties 814 indicate that a customization has been created for application 802, application 802 loads VSTO assembly loader 804. VSTO assembly loader 802 includes otkloadr.dll, which is an unmanaged DLL file configured to load customized assemblies. VSTO assembly loader 802 accesses document properties 814 to determine the name and location of the customized assembly, and loads the customized assembly. In the current example, the customized assembly is custom assembly 806.

Custom assembly 806 is generated in VSTO to enable smart tag functionality in document 812. Custom assembly 806 includes smart tag parameters, such as textual objects 202 and action 204 shown in FIG. 2. As shown in FIG. 8, custom assembly 818 includes a smart tag-to-document map 818. Map 818 maps smart tag parameters provided in custom assembly 806 to one or more documents. Custom assembly 818 may include smart tag functionality for more than one document. Map 818 indicates which portion of the smart tag functionality included in custom assembly 818 is directed for use in document 812.

VSTO runtime 808 is a program module of VSTO that executes when application 802 is running. VSTO runtime 808 provides a generic smart tag 810 to application 802, which is a template for smart tag functionality. Custom assembly 818 provides smart tag parameters 820, which are combined with generic smart tag 810, to provide smart tags to text of document 812 in application 802, including a smart tag 816.

FIGS. 7 and 8 described above show conventional smart tags implementations, where smart tags are associated with documents at an application suite level (FIG. 7) and directly at the document level (FIG. 8). Such implementations of smart tags have drawbacks. For example, such implementations are complex. Smart tag processing modules 712 and 804 shown in FIGS. 7 and 8 are both implemented as customized program code requiring customized interfaces for interacting with application suite 704 and document 806, respectively. The design of such customized software code is complex and prone to errors. Furthermore, registration of smart tags in these implementations is non-standard, requiring generation of special purpose registries (e.g., smart tag registry entries 702). With regard to FIG. 8, smart tags must be separately configured for each document in which the smart tags are desired to function.

Embodiments of the present invention enable smart tag functionality in documents in a less complex manner than in conventional implementations. In embodiments, smart tags are associated with documents at an application level using application add-in technology. Example embodiments are described in detail in the following section.

### Example Embodiments for Application Level Smart Tags

Example embodiments are described for associating smart tags with documents at an application level. For instance, embodiments described herein associate smart tags with documents at the application level using application add-in technology. The example embodiments described herein are provided for illustrative purposes, and are not limiting. For instance, some embodiments are described below in relation to the Microsoft® Office suite of applications. However, such embodiments are provided for purposes of illustration, and embodiments of the present invention are intended to be applicable to any suite of applications. Further structural and operational embodiments, including modifications/alterations, will become apparent to persons skilled in the relevant art(s) from the teachings herein.

In an embodiment, smart tag functionality is incorporated into an application add-in. An application add-in is a program module that interfaces and interacts with a host application to provide one or more functions to the host application. Add-ins may add many types of functionality to a host application. Examples of functionality provided to applications by commercially available add-ins include support for particular file formats, support for decryption/encryption, support for particular programming languages, an ability to play audio and/or video, etc.

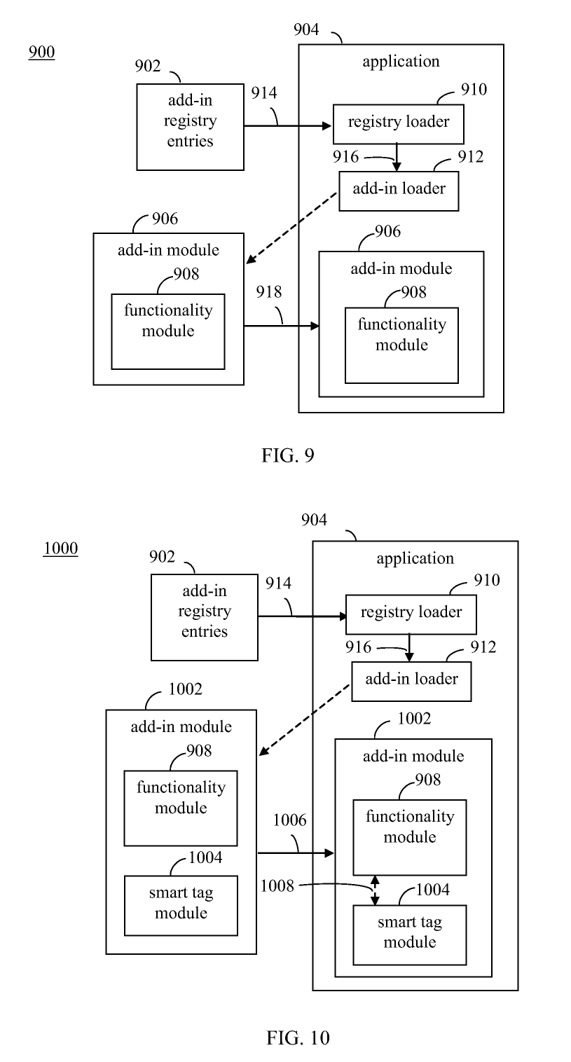

FIG. 9 shows a block diagram of a system 900 illustrating the loading of an add-in into an application. As shown in FIG. 9, system 900 includes add-in registry entries 902, an application 904, and an add-in module 906. Application 904 may be any application configured to run on a computer to enable a user to perform a task. Examples of application 904 include a word processing application, a spreadsheet application, a presentation generating application, a drawing application, etc. For instance, in one implementation, application 904 may be an application of Microsoft® Office, such as Microsoft® Word, Microsoft® Excel, Microsoft® Access™, Microsoft® PowerPoint®, and Microsoft® Outlook®. Alternatively, application 904 may be any application of an alternative application suite, as would be known to persons skilled in the relevant art(s). Examples of such alternative application suites include office suites such as iWork (published by Apple Inc. of Cupertino, Calif.), Corel Office (published by Corel Corporation of Ottawa, Ontario, Canada), Google Apps (published by Google Inc. of Mountain View, Calif.), Lotus Symphony (published by IBM Corporation of Armonk, N.Y.), and OpenOffice.org (published by Sun Microsystems, Inc. of Santa Clara, Calif.). Application 904 may be implemented in software, hardware, firmware, or any combination thereof.

As shown in FIG. 9, application 904 includes a registry loader 910 and an add-in loader 912. Registry loader 910 reads add-in registry entries 902. Add-in registry entries 902 may be Microsoft® Windows® registry entries, or any other suitable type of registry entries. In an embodiment, registry loader 910 may read add-in registry entries 902 upon the invoking of application 904. Many applications in Microsoft® Office (2007) look for add-in registry entries under the following key:
HKEY_CURRENT_USER\Software\Microsoft\Office\<appname>\Addins\<add-inID>
   where

<appname> is replaced with the actual application name, and

<add-inID> is replaced with the name of the add-in.

Alternative keys may be accessed for add-in registry information in other implementations. Add-in registry entries 902 may list the path, filename, and further information regarding one or more add-ins to be loaded by application 904, including add-in module 906. For the example key shown above, a “Manifest” registry entry provides the full path of the deployment manifest for an add-in. Add-in registry entries 902 may additionally include a “LoadBehavior” registry entry that provides information regarding how an add-in is to be loaded (e.g., at start-up, on demand, etc.).

Registry loader 910 generates an add-in load information signal 916, which includes the path and filename information for add-in module 906. Add-in load information 916 is received by add-in loader 912. Add-in loader 912 uses the information received in add-in load information 916 to load one or more add-ins, including add-in module 906. Add-in loader 912 loads add-in module 906 according to the provided information, as indicated by arrow 918 shown in FIG. 9. By loading add-in module 906 into application 904, a functionality module 908 contained by add-in module 906 is provided to application 904. Functionality module 908 provides additional functionality to application 904. Many types of functionality may be provided to application 904 by functionality module 908, such as support for particular file formats, support for decryption/encryption, support for particular programming languages, an ability to play audio and/or video, etc.

In an embodiment, smart tags are associated with an application by including smart tag functionality in an application add-in that is loaded by the application. Such embodiments provide advantages. For example, add-ins can be created by developers according to a standard process. Such an embodiment enables developers to build smart tag functionality into add-ins in a manner that is integrated with the standard add-in development process. Add-ins can be loaded into applications according to a standard interface. Because smart tag functionality is integrated with add-ins, the special purpose interface for interfacing smart tags with applications needed in conventional implementations is no longer necessary. Thus, smart tags can be provided in documents (via add-ins to applications) is a much less complex manner, and without as lengthy of a development process, as in conventional techniques.

Developers previously generated add-ins and smart tag functionality separately, with separate registration and loading behavior. In an embodiment, a single component is enabled to be generated—an add-in—which includes the desired add-in functionality along with smart tag functionality. Such an embodiment enables the development of add-ins and smart tags in a single development process, rather than in separate, parallel development paths. Furthermore, in an embodiment, the smart tag functionality embedded in the add-in may access some or all of the other functionality included in the add-in, if desired.

FIG. 10 shows a block diagram of a system 1000 illustrating the loading into an application of an add-in that incorporates smart tag functionality, according to an example embodiment. System 1000 is generally similar to system 900 shown in FIG. 9, with differences described as follows. As shown in FIG. 10, system 1000 includes add-in registry entries 902, application 904, and an add-in module 1002. Similarly to the description provided above, registry loader 910 reads add-in registry entries 902. Add-in registry entries 902 may list the path, filename, and further information regarding one or more add-ins to be loaded by application 904, including add-in module 1002. Registry loader 910 generates add-in load information signal 916, which includes the path and filename information for add-in module 1002. Add-in load information 916 is received by add-in loader 912. Add-in loader 912 uses the information received in add-in load information 916 to load one or more add-ins, including add-in module 1002, as indicated by arrow 1006 shown in FIG. 10.

As shown in FIG. 10, add-in module 1002 includes functionality module 908 and a smart tag module 1004. By loading add-in module 1002 into application 904, functionality module 908 and smart tag module 1004 are loaded into application 904. As described above, functionality module 908 provides functionality (e.g., non-smart tag related functionality) to application 904. Smart tag module 1004 enables smart tag functionality in documents opened in application 904, as described above. Such smart tag functionality includes creating smart tags in documents opened in application 904, and enabling actions to be initiated by interacting with the smart tags. In an embodiment, smart tag module 1004 and functionality module 908 may operate independently. In another embodiment, smart tag module 1004 and functionality module 908 may communicate with each other, as indicated in FIG. 10 by dotted arrow 1008. For instance, the smart tag functionality of smart tag module 1004 may access some or all of the other functionality included in functionality module 908, if desired. For example, one or more actions of smart tag module 1004 may be performed by functionality module 908.

In embodiments, add-in module 1002 and/or smart tag module 1004 may comprise software, such as a computer program, or a combination of hardware and software. Add-in module 1002 and smart tag module 1004 may be implemented according to any add-in/plug-in framework and using any suitable programming language, including any Microsoft® .NET™ programming language, C++, Borland® Delphi®, Java or JavaScript, Python, etc. Add-in module 1002 and/or smart tag module 1004 may be executed as one or more threads or processes running on one or more processors. Add-in module 1002 and smart tag module 1004 may be implemented as a system, method, apparatus, or article of manufacture using standard programming and/or engineering techniques to produce software, firmware, hardware, or any combination thereof to control a computer or processor-based device to implement aspects detailed herein. The term computer program as used herein is intended to encompass a computer program accessible from any computer-readable device, carrier or media. For example, computer-readable media can include but are not limited to magnetic storage device (e.g., hard disk, floppy disk, magnetic strips, or the like), optical disks (e.g., compact disk (CD), digital versatile disk (DVD), or the like), smart cards and flash memory devices.

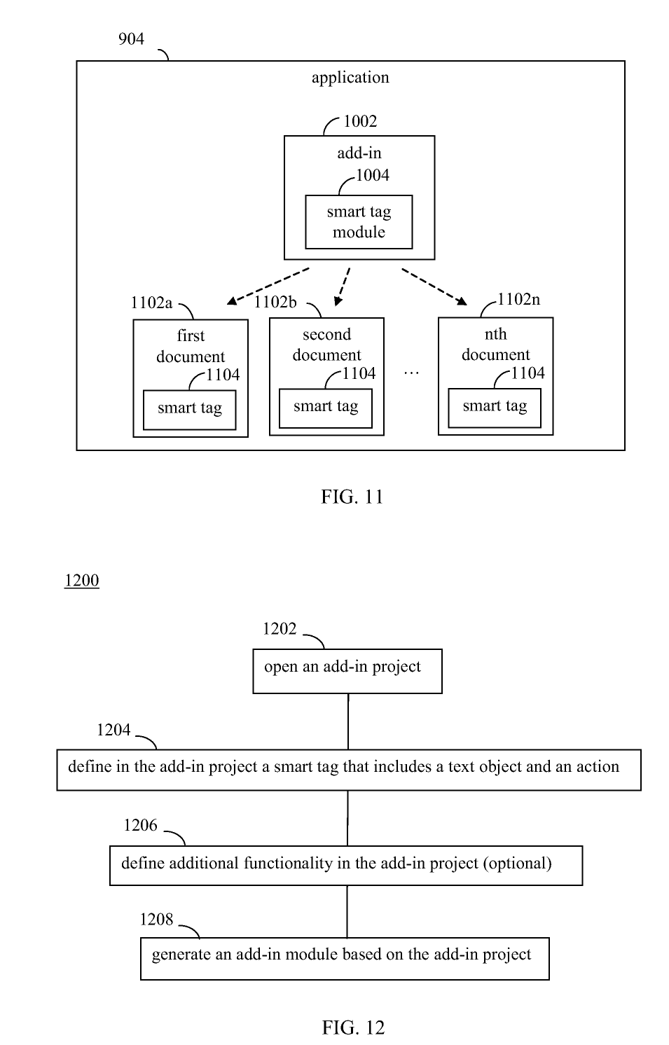

FIG. 11 shows a block diagram of application 904, according to an embodiment of the present invention. As shown in FIG. 11, application 904 has loaded add-in 1002, which includes smart tag module 1004. Furthermore, first-nth documents 1102a-1102n are shown open in application 904. First-nth documents 1102a-1102n may be open simultaneously, or at different instances of time. First-nth documents 1102a-1102n may be any number of documents 1102. As indicated in FIG. 11, smart tag module 1004 enables common smart tag functionality to each of first-nth documents 1102a-1102n. A set of one or more smart tags (based one on or more textual objects) is enabled in each of first-nth documents 1102a-1102n by smart tag module 1004. For example, a smart tag 1104 generated by smart tag module 1004 is present in each of first-nth documents 1102a-1102n (assuming that each of first-nth documents 1102a-1102n includes the textual object on which smart tag 1104 is based). Thus, a user that opens any of first-nth documents 1102a-1102n will be enabled by smart tag module 1004 to interact with smart tag 1104.

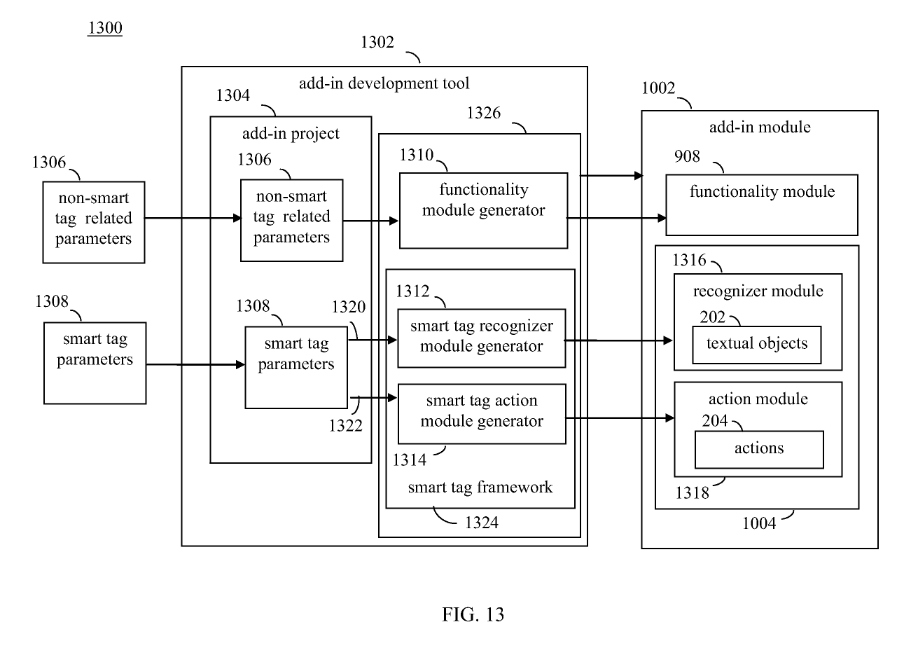

Add-in module 1002 may be generated in a variety of ways. For instance, FIG. 12 shows a flowchart 1200 for developing an add-in module, according to an example embodiment. Flowchart 1200 may be used by a user (e.g., a developer) to generate add-in module 1002 containing smart tag module 1004. Flowchart 1200 is described as follows with respect to an add-in development system 1300 shown in FIG. 13, according to an embodiment. As shown in FIG. 13, add-in development system 1300 includes an add-in development tool 1302. Further structural and operational embodiments will be apparent to persons skilled in the relevant art(s) based on the discussion regarding flowchart 1200.

Flowchart 1200 begins with step 1202. In step 1202, an add-in project is opened. For example, in an embodiment, an add-in project 1304 shown in FIG. 13 may be opened in add-in development tool 1302. Add-in development tool 1302 may include a user interface that enables a developer to interact with add-in project 1304. Add-in project 1304 is a data structure that allows a developer to group and save application objects being developed, such as add-ins. Add-in development tool 1302 may provide templates and/or other features to aid a developer in developing an application object in add-in project 1304. Add-in project 1304 may be saved as one or more files or in other data structure form. Add-in development tool 1302 may be any commercially available or proprietary tool that enables development of add-ins. For example, in an embodiment, add-in development tool 1302 may be Microsoft® Visual Studio® Tools for Office (VSTO), which is published by Microsoft Corporation of Redmond, Wash., and is a development tool for add-ins to Microsoft® Office applications. As shown in FIG. 13, add-in development tool 1302 includes an add-in module generator 1326, which includes a functionality module generator 1310 and a smart tag framework 1324. Functionality module generator 1310 enables add-in development tool 1302 to understand and process parameters for various types of functionality. Smart tag framework 1324 enables add-in development tool 1302 to understand and process smart tag parameters, including providing support for smart tag related code descriptors.

In step 1204, a smart tag is defined in the add-in project that includes a text object and an action. In an embodiment, a developer defines one or more smart tags in add-in project 1304. For example, as shown in FIG. 13, the developer may input smart tag parameters 1308 into add-in project 1304. Smart tag parameters 1308 include any parameters that a developer may use to define smart tags, including textual objects (e.g., textual objects 202 shown in FIG. 2) and actions (e.g., actions 204 shown in FIG. 2). As described above, the textual objects are typically one or more words/phrases to be searched for in a document for conversion into a smart tag. The actions include one or more actions to be made available to a user of the document when the smart tags associated with the textual objects are selected in the document.

Smart tag parameters 1308 may be entered into add-in project 1304 in any manner, including being entered (e.g., typed) by a developer as text, may be entered into add-in project 1304 using a user interface (e.g., a GUI) of add-in development tool 1302, may be loaded from a file, or may be entered into add-in project 1304 in any other manner. In an embodiment, smart tag parameters 1308 may be entered into a smart tag template of add-in project 1304, or may be entered in the form of program code or pseudocode.

For example, smart tag functionality may be desired for application 904 shown in FIG. 9 related to locations of interest. It may be desired to create a smart tag whenever the terms “Great Lakes Region,” “Grand Canyon,” and “Rocky Mountains” appear in a document. It is desired that a user be provide the option to invoke a mapping tool upon selection of the smart tag. Example code for defining a smart tag with this desired functionality is shown below, in two sections. The first code section is a “recognizer” code portion, and the second code section is an “action” code portion. The first code section (“recognizer” portion) is shown immediately below:

SmartTag st=new SmartTag (“myorg#location”, “Interesting Locations to See”);
st.Terms.Add (“Great Lakes Region”),
st.Terms.Add (“Grand Canyon”),
st.Terms.Add (“Rocky Mountains”);
   The first line of code shown above defines a new smart tag, having a smart tag type of “myorg#location,” and a title “Interesting Locations to See.” The second through fourth lines of code shown above each include the code term “st.Terms.Add” followed by a parameter that defines a textual object to be recognized in a document and converted into the smart tag.

The second code section (“action” portion) is shown immediately below:

Action sta=new Action (“Map this Location”);
st.Execute+={event handler for mapping the location};

VSTOSmartTags.Add(st);

The first two lines of code shown above define an action to be made available to a user and to be performed if the user selects the smart tag in a document. The third line of code shown above indicates an end of the current smart tag definition, and adds the smart tag definition to a collection to be provided in the add-in.

The first line of code of the second code section shown above provides the action with a title “Map this Location,” which may appear in a pop-up menu (e.g., in pop-up GUI 604). The second line of code uses a code term “st.Execute” to define an event handler to execute the action in the event that the action is selected in the pop-up menu. In this example, the event handler is configured to map the location of the recognized smart tag. Note that detailed program code is not provided for the event handler of the current example for purposes of brevity. Such an event handler for mapping a location, as in the current example, and/or for other suitable actions in further smart tag implementations, will be known to persons skilled in the relevant art(s). Furthermore, it is noted that although a single action is defined in the example code provided above, any number of additional actions may also be present. Such additional actions may be defined in a similar manner as shown above for the example location mapping action.

In step 1206, additional functionality is optionally defined in the add-in project. In an embodiment, a developer may define one or more functions (in addition to the smart tag functionality) for add-in project 1304. For example, as shown in FIG. 13, the developer may input non-smart related tag parameters 1306 into add-in project 1304 to define additional functionality. Any functionality suitable to be provided to an application using an add-in may be configured in step 1206.

In step 1208, an add-in module is generated based on the add-in project. For example, after configuring smart tag and optionally configuring further functionality in add-in project 1304, a user may close and/or save add-in project 1304. Add-in module generator 1326 of add-in development tool 1302 generates add-in module 1002 from add-in project 1304. Add-in module generator 1326 may process add-in project 1304 to generate add-in module 1002, including performing formatting, code compiling, packaging (e.g., with or without additional administrative code and/or header information), and/or other processing of the provided parameters.

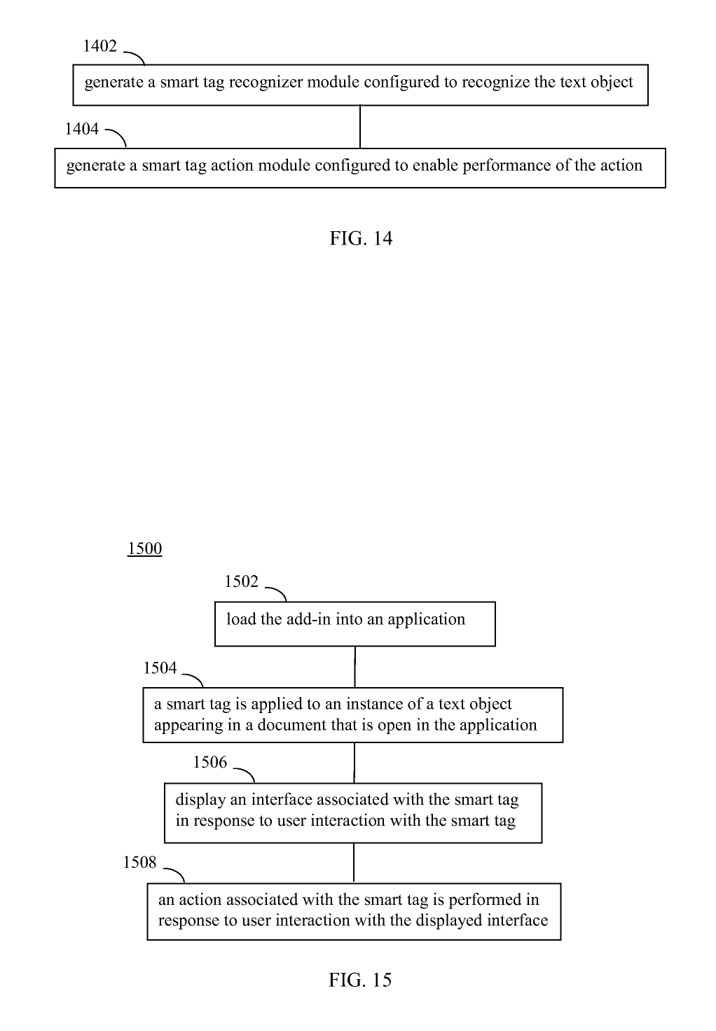

FIG. 14 shows a flowchart 1400 that may be performed during step 1208 of flowchart 1200, according to an example embodiment. In an embodiment, as shown in FIG. 13, smart tag framework 1324 may include a smart tag recognizer module generator 1312 and a smart tag action module generator 1314. Flowchart 1400 may be performed by smart tag recognizer module generator 1312 and smart tag action module generator 1314 to generate add-in module 1002. The steps of flowchart 1400 are described as follows. Note that the steps of flowchart 1400 may be performed in any order.

In step 1402, a smart tag recognizer module is generated that is configured to recognize the text object. As shown in FIG. 13, recognizer information 1320 of smart tag parameters 1308 is received by smart tag recognizer module generator 1312. Recognizer information 1320 includes information of smart tag parameters 1308 related to identifying smart tags in documents that was input into add-in project 1304. Recognizer information 1320 may include parameters, template data, code, pseudocode, etc. For instance, recognizer information 1320 may include the “recognizer” code portion provided above with respect to the location mapping smart tag example. Smart tag recognizer module generator 1312 processes recognizer information 1320 to generate a recognizer module 1316 (which includes textual objects 202, as described above). For example, smart tag recognizer module generator 1312 may compile code (if necessary), format, package, and/or otherwise process recognizer information 1320 to generate recognizer module 1316.

In step 1404, a smart tag action module is generated that is configured to enable performance of the action. As shown in FIG. 13, action information 1322 of smart tag parameters 1308 is received by smart tag action module generator 1312. Action information 1322 includes information of smart tag parameters 1308 related to actions that was input into add-in project 1304. Action information 1322 may include parameters, template data, code, pseudocode, etc. For instance, action information 1322 may include the “action” code portion provided above with respect to the location mapping smart tag example. Smart tag action module generator 1312 processes action information 1322 to generate an action module 1318 (which includes actions 204, as described above). For example, smart tag action module generator 1312 may compile code (if necessary), format, package, and/or otherwise process action information 1322 to generate action module 1318.

As described above, add-in development tool 1302 may include functionality module generator 1310. When non-smart tag related functionality is to be included in add-in module, non-smart tag related parameters 1306 may be received by functionality module generator 1310. Functionality module generator 1310 processes non-smart tag related parameters 1306 to generate a functionality module 908. For example, functionality module generator 1310 may compile code (if necessary), format, package, and/or otherwise process non-smart tag related parameters 1306 to generate functionality module 908.

Add-in module generator 1326, including functionality module generator 1310 and smart tag framework 1324 (which includes smart tag recognizer module generator 1312 and smart tag action module generator 1314), may be implemented in hardware, software, firmware, or any combination thereof.

As shown in FIG. 13, add-in module 1002 generated by add-in development tool 1302 includes functionality module 908 (when non-smart tag functionality is present) and smart tag module 1004, which includes recognizer module 1316 and action module 1318.

Add-in development tool 1302 generates add-in module 1002 in a form that is loadable by an application, such as application 904 shown in FIG. 11.

FIG. 15 shows a flowchart 1200 for enabling smart tag functionality in an application, according to an example embodiment. Further structural and operational embodiments will be apparent to persons skilled in the relevant art(s) based on the discussion regarding flowchart 1500. Flowchart 1500 is described as follows.

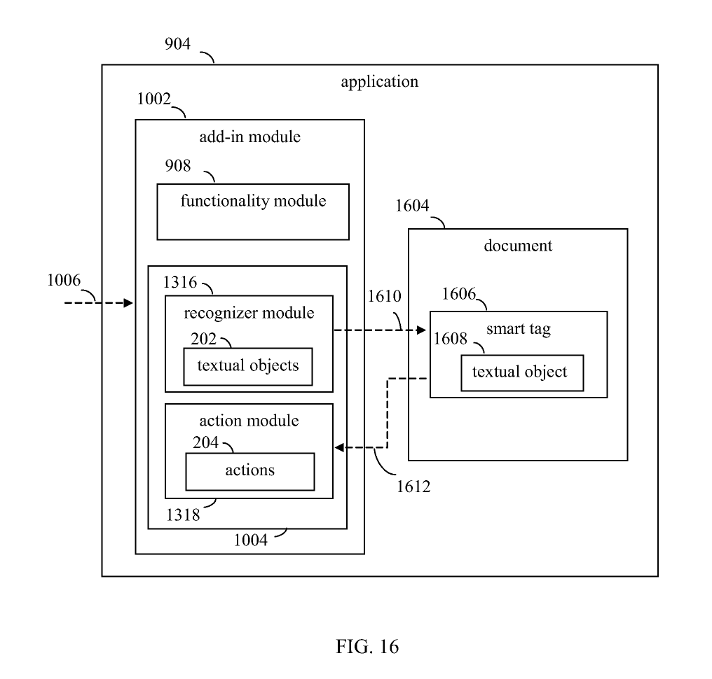

Flowchart 1500 begins with step 1502. In step 1502, the add-in is loaded into an application. For example, FIG. 16 shows a block diagram of add-in module 1002 of FIG. 13 loaded into application 904, according to an example embodiment of the present invention. Add-in module 1002 may be loaded at invocation of application 904, or may be loaded at a subsequent time. Loading add-in module 1002 into application 904 causes the execution of smart tag module 1004, which enables recognizer module 1316 and action module 1318 to perform their respective functions.

Add-in module 1002 may be loaded into application 904 in any manner, such as described above with respect to FIG. 10. Techniques for loading add-ins are known to persons skilled in the relevant art(s). In an embodiment, add-in development tool 1302 may be Microsoft® VSTO. VSTO runtime (installed on a computer running application 904) includes unmanaged components and a set of managed assemblies. The unmanaged components load add-in module 1002. The managed assemblies provide object models that add-in module 1002 may use to automate and extend the functionality of application 904 with smart tag functionality.

In step 1504, a smart tag is applied to an instance of a text object appearing in a document that is open in the application. For example, as shown in FIG. 16, a document 1604 is open in application 904. Recognizer module 1316 is configured to search text of document 1604 for textual objects 202. If the text of document 1604 includes one or more of the text/phrases of textual objects 202, recognizer module 1316 assigns a corresponding smart tag to each of the recognized text/phrases. For instance, a textual object 1608 in the text of document 1604 may be present in textual objects 202. Recognizer module 1316 recognizes textual object 1608 in document 1604, and applies a smart tag 1606 to textual object 1608 (as indicated by dotted arrow 1610 in FIG. 16). As described above, smart tag 1606 may be indicated in document 1604 in any manner, including as a dotted underline of textual object 1608. In an embodiment, recognizer module 1316 associates metadata with textual object 1608 so that subsequent interaction with smart tag 1606 may be detected.

Note that in an embodiment, recognizer module 1316 may include functionality for parsing text of document 1604. In another embodiment, application 1604 includes text parsing functionality (e.g., document parsing module 302 shown in FIG. 3), which is accessed by recognizer module 1316.

In step 1506, an interface associated with the smart tag is displayed in response to user interaction with the smart tag. In an embodiment, interaction with smart tag 1606 by a user causes a call to action module 1318 (as indicated by dotted arrow 1612 in FIG. 16). In response, action module 1318 provides a list of possible actions to be displayed by the interface. For example, based on the metadata associated with smart tag 1606, action module 1318 determines the identity of smart tag 1606, and can determine which actions to provide in the interface. Action module 1318 determines one or more actions corresponding to textual object 1608 of smart tag 1606 by reference to actions 204. For example, action module 1318 may provide the action “Map this Location,” as shown in FIG. 6, to be displayed in the interface, when textual object 1608 is “Great Lakes Region.”

Note that in an embodiment, action module 1318 may include functionality for displaying actions (e.g., in menu form as shown in FIG. 6) in document 1604. In another embodiment, application 1604 includes action display capability (e.g., action enabling module 304 shown in FIG. 3), which is accessed by action module 1318.

A user of application 904 may interact with smart tag 1606 in various ways, depending on the particular implementation of smart tag 1606. In an embodiment, as described above with respect to FIG. 6, a user may position a mouse pointer over smart tag 1606 to cause display of an interface, such as pop-up GUI 604. In one embodiment, a minimized menu (e.g., minimized menu 606 shown in FIG. 6) may be initially displayed due to interaction with smart tag 1606. The minimized menu may be expanded (e.g., into pop-up GUI 604) by user interaction, such as by the user clicking on the minimized menu. In another embodiment, the expanded menu may be displayed due to the initial interaction with smart tag 1606 by the user.

In step 1508, an action associated with the smart tag is performed in response to user interaction with the displayed interface. In an embodiment, interaction with the interface displayed for smart tag 1606 (in step 1506) causes a call to action module 1318. In response, action module 1318 performs the action selected by the user in the displayed interface. For example, an event handler provided in actions 204 for the selected action may be executed to perform the action.

### Example Computer System

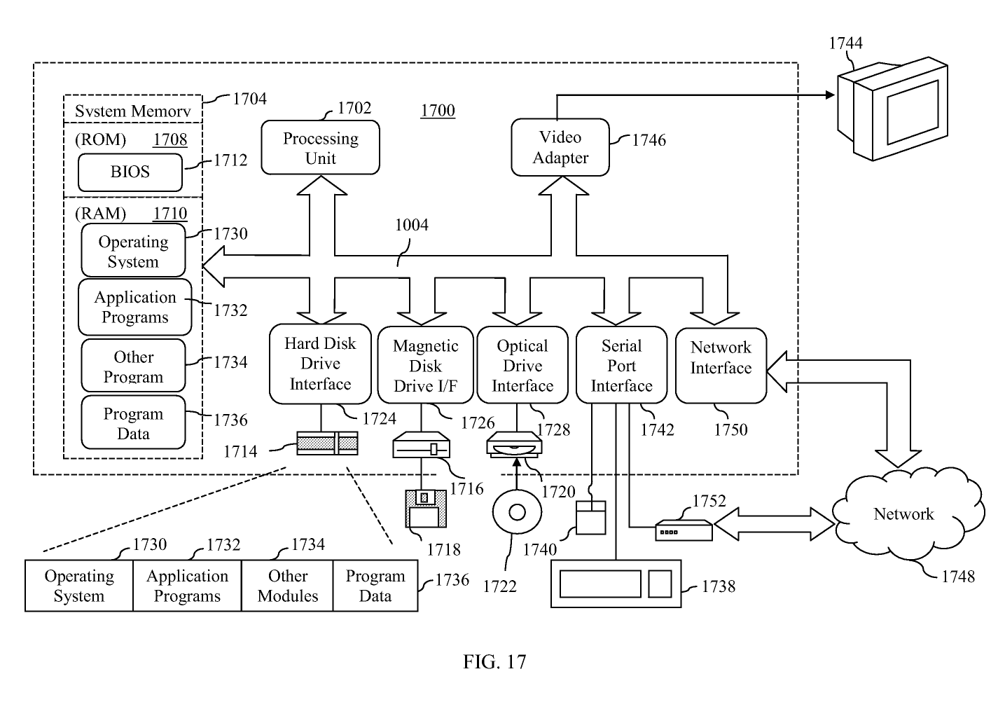

FIG. 17 depicts an exemplary implementation of a computer 1700 in which embodiments of the present invention may be implemented. For example, an application suite that includes application 904 (e.g., shown in FIGS. 9-11 and 16) may be implemented on computer 1700. Furthermore, add-in development tool 1302 (shown in FIG. 13) may be implemented on computer 1700. Computer 1700 may be a general-purpose computing device in the form of a conventional personal computer, a mobile computer, or a workstation, for example.

As shown in FIG. 17, computer 1700 includes a processing unit 1702, a system memory 1704, and a bus 1706 that couples various system components including system memory 1704 to processing unit 1702. Bus 1706 represents one or more of any of several types of bus structures, including a memory bus or memory controller, a peripheral bus, an accelerated graphics port, and a processor or local bus using any of a variety of bus architectures. System memory 1704 includes read only memory (ROM) 1708 and random access memory (RAM) 1710. A basic input/output system 1712 (BIOS) is stored in ROM 1708.

Computer 1700 also has one or more of the following drives: a hard disk drive 1714 for reading from and writing to a hard disk, a magnetic disk drive 1716 for reading from or writing to a removable magnetic disk 1718, and an optical disk drive 1720 for reading from or writing to a removable optical disk 1722 such as a CD ROM, DVD ROM, or other optical media. Hard disk drive 1714, magnetic disk drive 1716, and optical disk drive 1720 are connected to bus 1706 by a hard disk drive interface 1724, a magnetic disk drive interface 1726, and an optical drive interface 1728, respectively. The drives and their associated computer-readable media provide nonvolatile storage of computer-readable instructions, data structures, program modules and other data for the computer. Although a hard disk, a removable magnetic disk and a removable optical disk are described, other types of computer-readable media can be used to store data, such as flash memory cards, digital video disks, random access memories (RAMs), read only memories (ROM), and the like.

A number of program modules may be stored on the hard disk, magnetic disk, optical disk, ROM, or RAM. These programs include an operating system 1730, one or more application programs 1732, other program modules 1734, and program data 1736. Application programs 1732 or program modules 1734 may include, for example, logic for implementing add-in development tool 1302 and/or add-in module 1002, as described above.

A user may enter commands and information into the computer 1700 through input devices such as keyboard 1738 and pointing device 1740. Other input devices (not shown) may include a microphone, joystick, game pad, satellite dish, scanner, or the like. These and other input devices are often connected to the processing unit 1702 through a serial port interface 1742 that is coupled to bus 1706, but may be connected by other interfaces, such as a parallel port, game port, or a universal serial bus (USB).

A monitor 1744 or other type of display device is also connected to bus 1706 via an interface, such as a video adapter 1746. Monitor 1744 is used to present a graphical user interface that assists a user/operator in interacting with add-in development tool 1302 or application 904, for example. In addition to the monitor, computer 1700 may include other peripheral output devices (not shown) such as speakers and printers.

Computer 1700 is connected to a network 1748 (e.g., the Internet) through a network interface or adapter 1750, a modem 1752, or other means for establishing communications over the network. Modem 1752, which may be internal or external, is connected to bus 1706 via serial port interface 1742.

As used herein, the terms “computer program medium” and “computer-readable medium” are used to generally refer to media such as the hard disk associated with hard disk drive 1714, removable magnetic disk 1718, removable optical disk 1722, as well as other media such as flash memory cards, digital video disks, random access memories (RAMs), read only memories (ROM), and the like.

As noted above, computer programs and modules (including application programs 1732 and other program modules 1734) may be stored on the hard disk, magnetic disk, optical disk, ROM, or RAM. Such computer programs may also be received via network interface 1750 or serial port interface 1742. Such computer programs, when executed or loaded by an application, enable computer 1700 to implement features of the present invention discussed herein. Accordingly, such computer programs represent controllers of the computer 1700.

The invention is also directed to computer program products comprising software stored on any computer useable medium. Such software, when executed in one or more data processing devices, causes a data processing device(s) to operate as described herein.

Embodiments of the present invention employ any computer-useable or computer-readable medium, known now or in the future. Examples of computer-readable mediums include, but are not limited to storage devices such as RAM, hard drives, floppy disks, CD ROMs, DVD ROMs, zip disks, tapes, magnetic storage devices, optical storage devices, MEMs, nanotechnology-based storage devices, and the like.

### Conclusion

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents

What is claimed is:

1. A system, comprising:
an application add-in module configured to be loaded into an application, the application add-in module including a smart tag module configured to enable smart tag functionality in the application, the smart tag module including
a recognizer module configured to recognize a textual object in a plurality of documents open in an application in which the application add-in module is loaded, and to assign a smart tag to the recognized textual object, and
an action module configured to indicate an action in an interface provided in a document proximate to the smart tag if a user interacts with the smart tag in the document, and to enable the action to be performed if the user selects the action in the provided interface.

2. The system of claim 1, wherein the action module is configured to enable a list of actions to be indicated in the interface provided in the document proximate to the smart tag if a user interacts with the smart tag in the document;
wherein the action module is configured to enable an action selected from the list of actions to be performed.

3. The system of claim 1, wherein the add-in module is configured to be loadable into an application of an application suite.

4. The system of claim 1, further comprising:
a functionality module that enables non-smart tag related functionality.

5. The system of claim 1, wherein the action module includes an event handler configured to perform the action.

6. The system of claim 4, wherein the action module includes an event handler configured to perform the action, the event handler being configured to access functionality of the functionality module

7. A method of generating an application add-in module, comprising:
opening an add-in project;
defining in the add-in project a smart tag that includes a textual object and an action; and
generating an add-in module based on the add-in project that is configured to be loaded into an application.

8. The method of claim 7, further comprising:
defining non-smart related functionality in the add-in project.

9. The method of claim 7, wherein said generating comprises:
generating a smart tag recognizer module configured to recognize the textual object in a plurality of documents open in an application in which the application add-in module is loaded and to assign the smart tag to the recognized textual object;
generating a smart tag action module configured to enable performance of the action; and
including the generated smart tag recognizer module and the generated smart tag action module in the add-in module.

10. The method of claim 9, wherein said generating a smart tag action module configured to enable performance of the action comprises:
configuring the action module to indicate the action in an interface proximate to the smart tag in a document open in the application if a user interacts with the smart tag in the document; and
configuring the action module to enable the action to be performed if the user selects the action in the interface.

11. The method of claim 7, wherein said configuring the action module to enable the action to be performed if the user selects the action in the interface comprises:
including an event handler configured to perform the action in the action module.

12. The method of claim 7, wherein said generating comprises:
configuring the add-in module to be loadable into an application of an application suite.

13. An add-in development tool, comprising:
a user interface that enables a user to interact with an add-in project, the add-in project being configured to receive smart tag parameters including at least one textual object and at least one action; and
an add-in module generator configured to generate an add-in module, the add-in module generator including
a smart tag framework configured to process the received smart tag parameters, and to generate a smart tag module included in the generated add-in module.

14. The add-in development tool of claim 13, wherein the add-in project is further configured to receive non-smart tag related parameters; and
the add-in module generator further including
a functionality module generator configured to process the received non-smart tag related parameters, and to generate a functionality module included in the generated add-in module.

15. The add-in development tool of claim 13, wherein the smart tag framework includes a smart tag recognizer module generator and a smart tag action module generator;
the smart tag recognizer module generator being configured to generate a smart tag recognizer module configured to recognize the textual object in a plurality of documents open in an application in which the application add-in module is loaded and to assign the smart tag to the recognized textual object;
the smart tag action module generator being configured to generate a smart tag action module configured to enable performance of the action; and
the generated smart tag recognizer module and the generated smart tag action module being included in the smart tag module.

16. The add-in development tool of claim 13, wherein the smart tag action module generator is configured to include an event handler in the smart tag action module that is configured to perform the action.

17. The add-in development tool of claim 14, wherein the smart tag action module generator is configured to include an event handler in the smart tag action module that is configured to perform the action, the event handler being configured to access functionality of the functionality module

18. The add-in development tool of claim 13, wherein the add-in module generator is configured to configure the add-in module to be loadable into an application of an application suite.
